(19) United States
(12) Patent Application Publication
(10) Pub. No.: US 2025/0222570 A1
(43) Pub. Date: Jul. 10, 2025

(54) CARBON FIBER REACTION ARM FOR A POWER TOOL

(71) Applicant: MILWAUKEE ELECTRIC TOOL CORPORATION, Brookfield, WI (US)

(72) Inventor: Mitchell A. Gibson, New Berlin, WI (US)

(21) Appl. No.: 19/009,416

(22) Filed: Jan. 3, 2025

Related U.S. Application Data
(60) Provisional application No. 63/617,672, filed on Jan. 4, 2024.

(51) Int. Cl. B25B 23/00; B25B 21/00; B25F 5/00

(52) U.S. Cl. CPC B25B 23/0078; B25B 21/00; B25F 5/001

(57) ABSTRACT

A power tool includes a housing, an output operable to apply torque to a fastener, and a reaction arm having a body with a first end coupled to the housing and a second end configured to engage a fixed structure to bear a reaction torque as the output applies torque to the fastener. The body of the reaction arm is made of carbon fiber.

### CROSS-REFERENCE TO RELATED APPLICATIONS

This application claims priority to U.S. Provisional Patent Application No. 63/617,672, filed Jan. 4, 2024, the entire content of which is incorporated herein by reference.

### FIELD OF THE DISCLOSURE

The present disclosure relates to power tools, and, more specifically, to reaction arms for power tools.

### BACKGROUND

Reaction arm tools are a form of rotary power tool used to drive fasteners, such as nuts and bolts, particularly in high torque applications. Reaction arm tools include a reaction arm fixed to a housing of the tool and engageable with a fixed structure (e.g., an adjacent fastener in a bolt pattern). When applying torque to a fastener, the reaction arm transmits the reaction torque to the fixed structure rather than to a user holding the tool.

### SUMMARY

Manufacturing reaction arms can be difficult and costly. First, reaction arms may have a variety of complex geometries to suit a particular application. Reaction arms must also be strong enough to resist high torque loads. Finally, it is desirable for reaction arms to have high wear resistance, particularly in regions where the reaction arm may contact the fixed structure and where the reaction arm couples to the housing of the tool. Reaction arms have typically been forged from steel to provide the requisite strength and wear resistance. However, forged steel reaction arms are heavy, resulting in operator fatigue. Complex geometries may also lead to high stress concentrations, which may negatively affect durability.

Accordingly, the present disclosure provides, among other things, a reaction arm tool with an improved reaction arm.

For example, in some aspects, the techniques described herein relate to a power tool including: a housing; an output operable to apply torque to a fastener; and a reaction arm having a body with a first end coupled to the housing and a second end configured to engage a fixed structure to bear a reaction torque as the output applies torque to the fastener, wherein the body of the reaction arm is made of carbon fiber.

In some aspects, the techniques described herein relate to a power tool, wherein the reaction arm includes an insert made of metal.

In some aspects, the techniques described herein relate to a power tool, wherein the insert is a first insert located proximate the first end, and wherein the reaction arm includes a second insert located proximate the second end.

In some aspects, the techniques described herein relate to a power tool, wherein the first insert and the second insert are at least partially embedded in the body.

In some aspects, the techniques described herein relate to a power tool, wherein the insert includes a peripheral flange embedded within the body.

In some aspects, the techniques described herein relate to a power tool, wherein the insert has an inner surface with a spline geometry configured to cooperate with a corresponding spline geometry on the housing of the power tool.

In some aspects, the techniques described herein relate to a power tool, wherein the housing includes a motor housing portion, a handle extending from the motor housing portion, and a gear case extending from the motor housing portion, and wherein the power tool includes a motor supported within the motor housing portion and a multi-stage planetary transmission supported within the gear case and coupled between the motor and the output.

In some aspects, the techniques described herein relate to a power tool, wherein the corresponding spline geometry on the housing of the power tool is formed on the gear case.

In some aspects, the techniques described herein relate to a power tool, wherein the gear case includes a plurality of internal teeth defining a ring gear of the multi-stage planetary transmission.

In some aspects, the techniques described herein relate to a power tool, wherein the insert is made of titanium.

In some aspects, the techniques described herein relate to a power tool, wherein the reaction arm includes an arcuate slot defined by the insert.

In some aspects, the techniques described herein relate to a power tool, wherein the reaction arm includes a socket slidable along the arcuate slot.

In some aspects, the techniques described herein relate to a power tool, wherein the insert includes a T-shaped extension embedded within the body of the reaction arm.

In some aspects, the techniques described herein relate to a power tool including: a housing; an output operable to apply torque to a fastener; and a reaction arm having a body with a first end coupled to the housing and a second end configured to engage a fixed structure to bear a reaction torque as the output applies torque to the fastener, wherein at least a portion of the reaction arm is made of titanium.

In some aspects, the techniques described herein relate to a power tool, wherein the reaction arm includes a body made of carbon fiber and an insert made of titanium.

In some aspects, the techniques described herein relate to a power tool, wherein the insert is at least partially embedded within the body.

In some aspects, the techniques described herein relate to a power tool, wherein the insert is a first insert, the first insert being engageable with the housing to rotationally fix the reaction arm relative to the housing, and wherein the reaction arm further includes a second insert at least partially embedded within the body, the second insert including a surface configured to engage the fixed structure.

In some aspects, the techniques described herein relate to a reaction arm for use with a power tool, the reaction arm including: a body made of carbon fiber, the body having a first end configured to be coupled to the power tool and a second end configured to engage a fixed structure to bear a reaction torque; a first insert coupled to the body proximate the first end; and a second insert coupled to the body proximate the second end, wherein the first insert and the second insert are made of a different material than the body.

In some aspects, the techniques described herein relate to a reaction arm, wherein the first insert and the second insert are made of metal.

In some aspects, the techniques described herein relate to a reaction arm, wherein the first insert and second insert are made of titanium.

Other features and aspects of the present disclosure will become apparent upon consideration of the following detailed description and accompanying drawings.

### BRIEF DESCRIPTION OF THE DRAWINGS

FIG. 1 is a perspective view of a power tool including a reaction arm according to an embodiment of the disclosure.

FIG. 2 is a cross-sectional view of the power tool of FIG. 1.

FIG. 3 is an enlarged cross-sectional view illustrating a drive assembly of the power tool of FIG. 1.

FIG. 4 is a perspective view of a reaction arm according to an embodiment of the disclosure and which may be used with the power tool of FIG. 1.

FIG. 5 is a perspective view of a tip insert of the reaction arm of FIG. 4.

FIG. 6 is a perspective view of a spline insert of the reaction arm of FIG. 4.

FIG. 7A is a perspective view of a reaction arm according to another embodiment of the disclosure and which may be used with the power tool of FIG. 1.

FIG. 7B is a perspective view of a reaction arm according to another embodiment of the disclosure and which may be used with the power tool of FIG. 1.

FIG. 7C is a perspective view of a reaction arm according to another embodiment of the disclosure and which may be used with the power tool of FIG. 1.

FIG. 7D is a perspective view of a reaction arm according to another embodiment of the disclosure and which may be used with the power tool of FIG. 1.

FIG. 7E is a perspective view of a reaction arm according to another embodiment of the disclosure and which may be used with the power tool of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

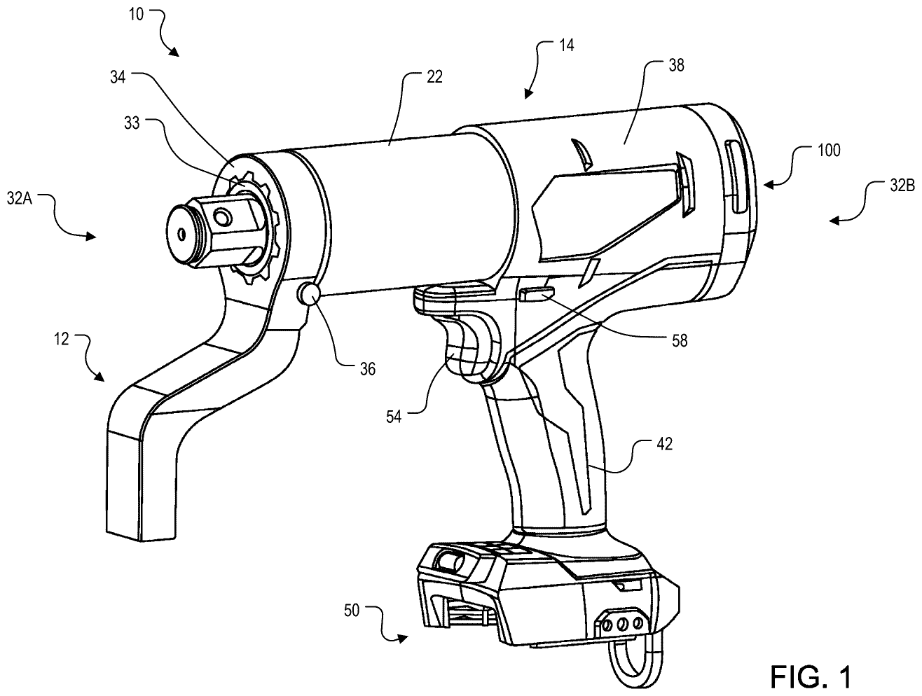

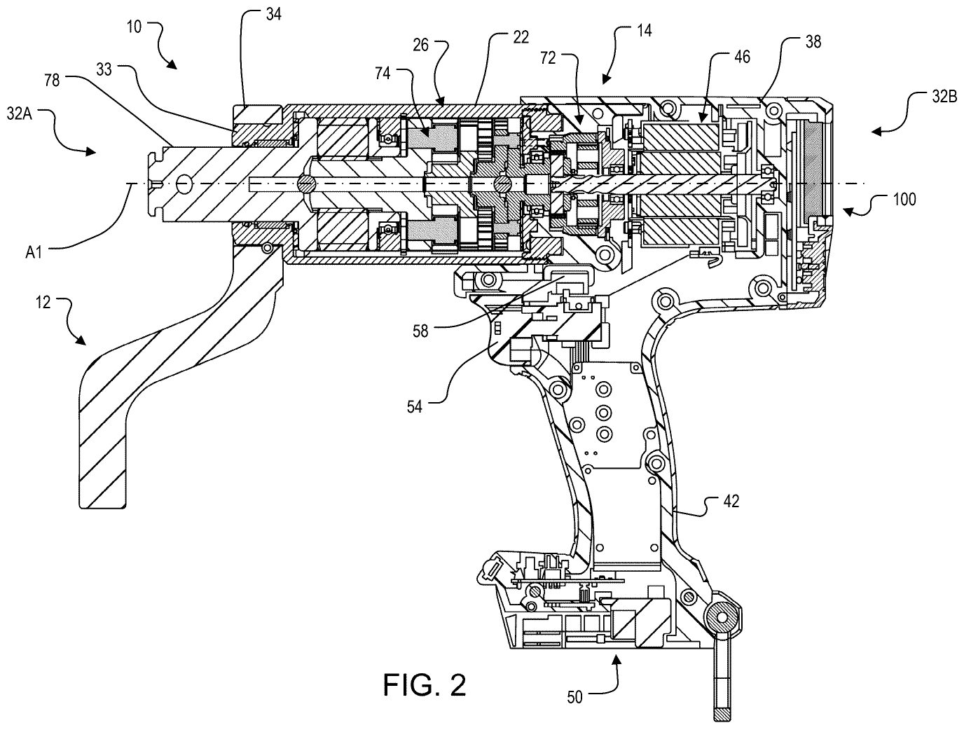

FIGS. 1-2 illustrate a power tool 10 configured to apply torque to a workpiece (e.g., a fastener). The illustrated power tool 10 is configured as a reaction arm tool and includes a reaction arm 12, a housing 14, a drive assembly 26, and a user interface assembly 100. The power tool 10 defines a front end 32A facing the workpiece (not shown) during operation and a rear end 32B opposite the front end 32A.

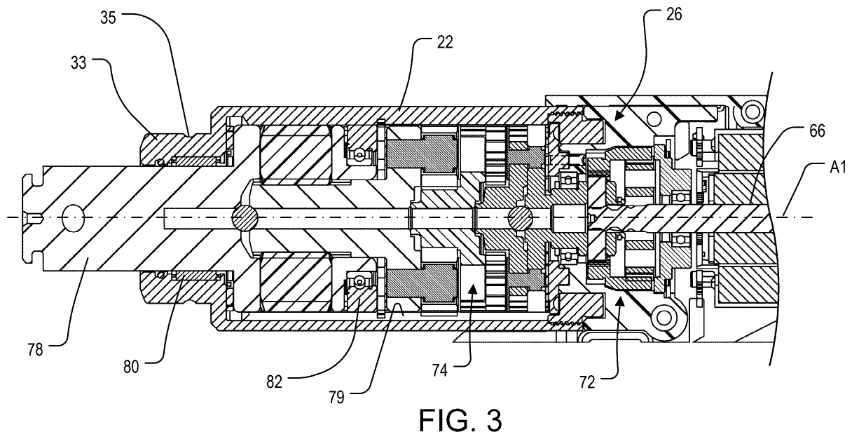

With continued reference to FIGS. 1-2, the illustrated housing 14 includes a gear case 22, and the reaction arm 12 is removably coupled to the gear case 22. More specifically, in the illustrated embodiment, the reaction arm 12 is coupled to a splined nose 33, which defines a front end of the gear case 22. The reaction arm 12 has a collar portion 34 that surrounds the nose 33 of the gear case 22 and that includes internal splines engageable with the external splines on the nose 33 to rotationally fix the reaction arm 12 relative to the gear case 22. Best illustrated in FIG. 3, the nose 33 of the gear case 22 in the illustrated embodiment includes a circumferential groove 35. The reaction arm 12 may include a locking mechanism 36 (FIG. 1) configured to interface with the groove 35 to axially retain the reaction arm 12 on the nose 33. The locking mechanism 36 may be actuated by a user to disengage from the groove 35 and permit removal and/or replacement of the reaction arm 12 (e.g., with other compatible reaction arms, such as the reaction arms 12′ and 12A-E described in greater detail below). In other embodiments, the reaction arm 12 may be configured to couple to other parts of the housing 14.

The reaction arm 12 is configured to engage and brace against a fixed structure (e.g., an adjacent fastener, a wall, a clamp, etc.). When the reaction arm 12 braces against the fixed structure, the reaction torque generated by the drive assembly 26 is negated and an operator does not need to counteract the reaction torque. As such, the operator using the power tool 10 does not experience the reaction torque on their hands and wrists allowing for higher torque outputs, repeatability, and reduced operator fatigue.

With continued reference to FIGS. 1-2, the illustrated housing 14 includes a motor housing portion 38 and a handle portion 42 extending from the motor housing portion 38. The motor housing portion 38 and handle portion 42 may be defined by cooperating clamshell halves. In the illustrated embodiment, the gear case 22 is coupled to and extends from the motor housing portion 38. The motor housing portion 38 encloses and supports a motor 46 (FIG. 2), which is the prime mover of the drive assembly 26. The motor 46, which in the illustrated embodiment is a brushless, direct-current motor, is configured to rotate a motor shaft 66 around a central axis A1.

The handle portion 42 is configured to be gripped by the operator during use of the power tool 10. In the illustrated embodiment, the handle portion 42 defines a pistol grip. The illustrated handle portion 42 includes a battery receptacle 50 at its lower end, a trigger 54, and a forward/reverse switch 58. The battery receptacle 50 is configured to couple a battery pack (not shown) mechanically and electrically to the power tool 10 to provide power to the motor 46 (e.g., in response to actuation of the trigger 54). The trigger 54 may be a variable speed trigger able to vary an operating speed of the motor 46 depending on an extent of actuation of the trigger 54. In other embodiments, the trigger 54 may function as an on/off switch. The forward/reverse switch 58 is configured to set a direction of rotation of the motor 46 (e.g., a tightening direction and a loosening direction).

With reference to FIGS. 2-3, the drive assembly includes a first planetary transmission assembly 72, a second planetary transmission assembly 74, and an output drive 78. The first planetary transmission assembly 72 includes a plurality of planetary gear stages (e.g., two gear stages), with a first stage meshed within a pinion fixed to or integrally formed with the motor shaft 66. An output of the last stage of the first planetary transmission assembly 72 provides a torque input (e.g., as a sun gear) to a first planetary gear stage of a plurality of planetary gear stages (e.g., four gear stages) of the second planetary transmission assembly 74. In the illustrated embodiment, the interior of the gear case 22 includes gear teeth 79 extending parallel to the axis A1 such that the gear case 22 defines a common ring gear for each of the plurality of gear stages of the second planetary transmission assembly 74.

The illustrated output drive 78 defines a last stage carrier of the second planetary transmission assembly 74 and extends from the front end of the gear case 22. The output drive 78 is rotatably supported by a first bearing 80 and a second bearing 82. In the illustrated embodiment, the first bearing 80 is received within the nose 33 of the gear case 22. The first bearing 80 is a needle bearing in the illustrated embodiment to facilitate accommodation of the first bearing 80 within the reduced diameter of the nose 33.

The output drive 78 is configured to receive a tool bit (e.g., a socket; not shown) and rotate the tool bit about the axis A1. The tool bit may engage a fastener and apply torque generated by the motor 46 and amplified by the drive assembly 26 to tighten or loosen the fastener. In the illustrated embodiment, the output drive 78 includes a square drive (e.g., a 1-inch square drive, a ¾-inch square drive, or the like). In other embodiments, the output drive 78 may include a splined shaft, a hex shaft, a D shaft, a double D shaft, or the like. In yet other embodiments, the output drive 78 may include a chuck or bit holder.

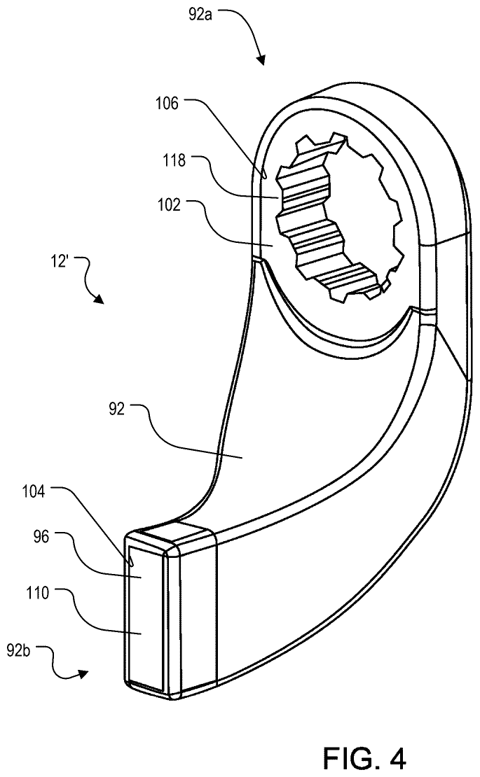

FIG. 4 illustrates a reaction arm 12′ according to an embodiment of the present disclosure and which may be used with the power tool 10. The illustrated reaction arm 12′ includes a body 92 having an attachment end or first end 92a and a distal end or second end 92b. The attachment end 92a is configured to be coupled to the gear case 22 of the power tool 10, such that the body 92 extends away from the gear case 22 to the distal end 92b. In the illustrated embodiment, the body 92 is made of a carbon fiber composite material, including carbon fibers and a binder material, such as epoxy. A carbon fiber composite material may be referred to herein simply as carbon fiber. As such, the body 92 of the reaction arm 12′ may be formed via a carbon fiber manufacturing process. The carbon fiber construction of the body 92 provides high strength with significantly less weight than typical steel reaction arms. In other embodiments, the body 92 may be formed of other fiber-reinforced composite materials, glass-reinforced composite materials, or the like.

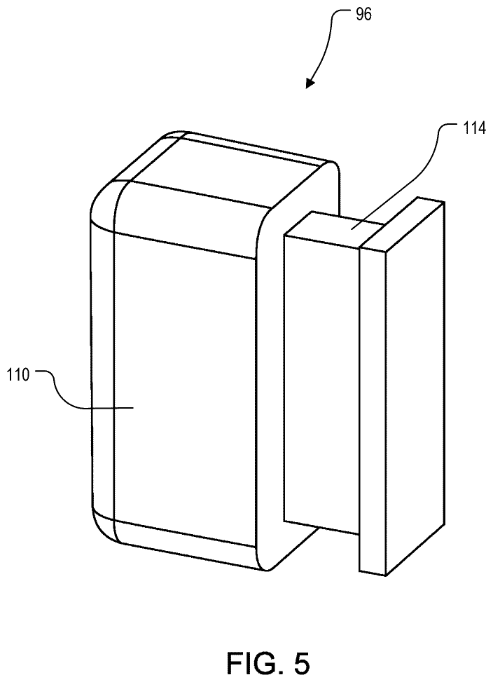

The illustrated reaction arm 12′ further includes a tip insert 96 (FIG. 5) and a spline insert 102 (FIG. 6). The tip insert 96 and the spline insert 102 are received in corresponding recesses 104, 106 within the body 92 of the reaction arm 12′. In some embodiments, the tip insert 96 and the spline insert 102 are molded within the body 92 during formation of the body 92.

The tip insert 96 includes a body 110 and an extension 114. At least a portion of the body 110 is externally exposed relative to the body 92 of the reaction arm 12′. The illustrated extension 114 is generally T-shaped and may extend into the body 92 of the reaction arm 12′ such that the extension 114 is embedded within the carbon fiber composite material of the body 92, thereby improving retention/coupling between the tip insert 96 and the body 92.

Referring to FIG. 6, the spline insert 102 includes a plurality of teeth 118 formed circumferentially around an inner surface of the spline insert 102 and a flange 120, having a generally T-shaped cross-section, extending circumferentially and defining the outer periphery of the spline insert 102. The teeth 118 form a spline geometry and are configured to cooperate with the spline geometry on the nose 33 of the gear case 22 to mount the reaction arm 12′ to the power tool 10 (e.g., in the same manner as the reaction arm 12 described above). The flange 120 may be embedded within the carbon fiber composite material of the body 92, thereby improving retention/coupling between the spline insert 102 and the body 92.

Although carbon fiber has a high strength to weight ratio, the tip insert 96 and the spline insert 102 may be made of a material with higher wear resistance than the carbon fiber material of the body 92 for increased durability. In the illustrated embodiment, the tip insert 96 and the spline insert 102 are made of titanium and formed by metal injection molding or investment casting. However, the tip insert 96 and the spline insert 102 may be made from other materials (e.g., steel) and via other suitable methods (e.g., powdered metal processing, etc.).

With reference to FIG. 4, the tip insert 96 and the spline insert 102 are attached to portions of the body 92 that may most wear during operation of the power tool 10. That is, in operation of the power tool 10, the tip insert 96 may brace the tool 10 against a fixed structure (e.g., an adjacent fastener, a wall, a clamp, etc.) to bear the reaction torque. As such, the exposed portion of the body 110 of the tip insert 96 may contact and press against the fixed structure. Further, in operation of the power tool 10, the spline insert 102 may bear against the splines on the nose 33 of the gear case 22 of the power tool 10 for the transmission of reaction torque from the power tool 10 to the reaction arm 12′. Thus, the tip insert 96 and the spline insert 102 are advantageously formed with a material (e.g., titanium) that is more resistant to wear than the material of the body 92 (e.g., carbon fiber).

In some embodiments, the reaction arm 12′ may be made entirely of a lightweight and high-strength metal or metal alloy. For example, in some embodiments, the reaction arm 12′ is made of titanium. In such embodiments, the tip insert 96 and the spline insert 102 may be omitted, since the titanium material of the reaction arm 12′ has both high strength and high wear resistance. In other embodiments, the body 92 of the reaction arm 12′ may be made of a first metal (e.g., an aluminum alloy, a magnesium alloy, or the like) and the tip insert 96 and the spline insert 102 may be made of a second metal (e.g., titanium, steel, or the like) with a higher wear resistance than the first metal.

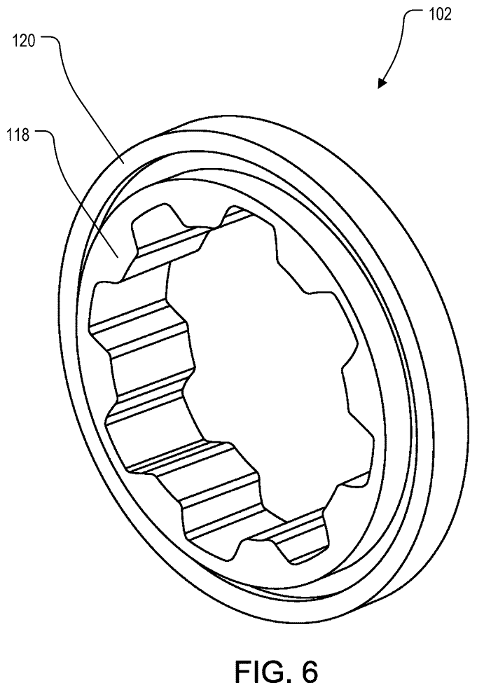

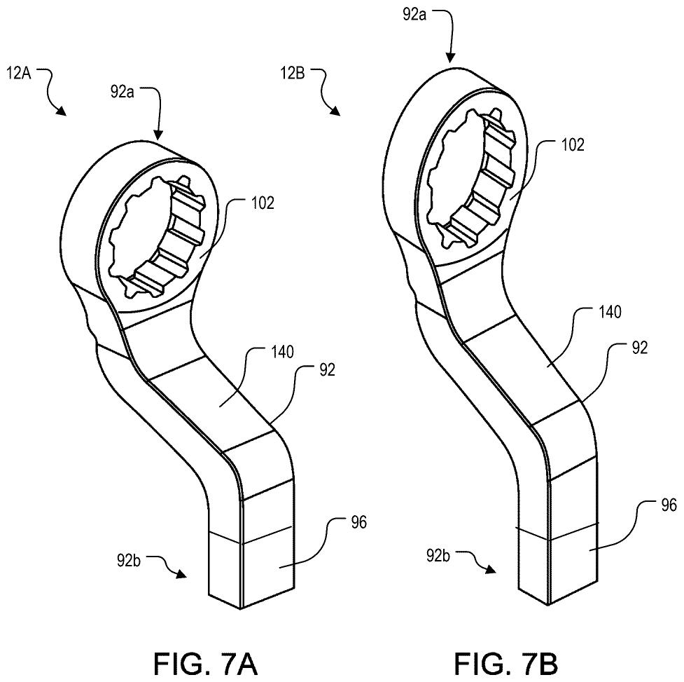

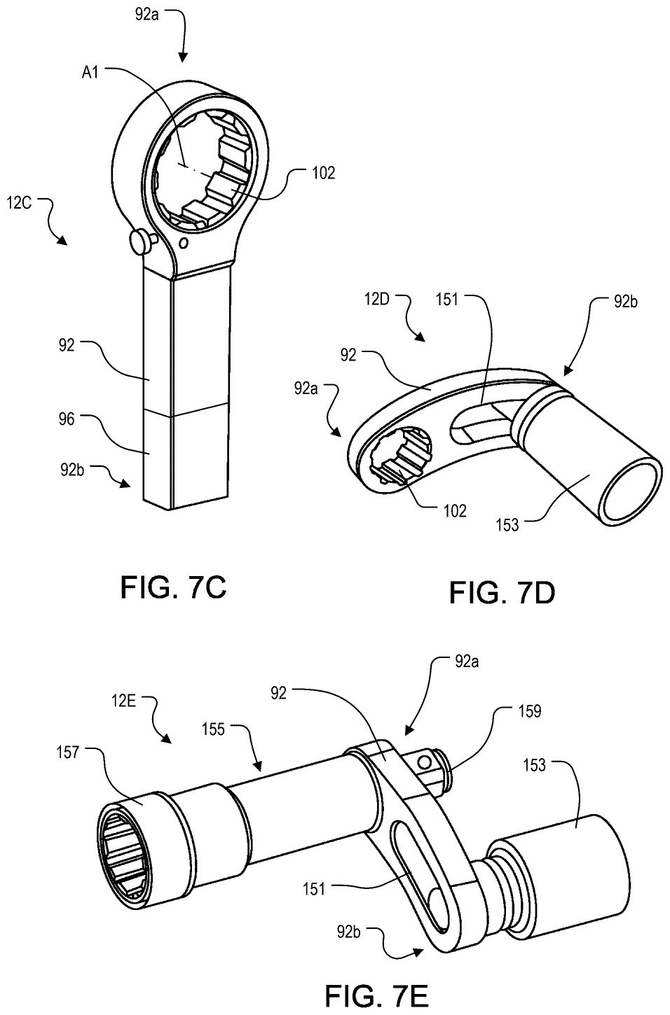

FIGS. 7A-7E illustrate additional reaction arms 12A, 12B, 12C, 12D, 12E that may be used with the power tool 10 (e.g., in place of the reaction arm 12′). Like the reaction arm 12′, each of the reaction arms 12A-12E may be made of carbon fiber composite material and may include a tip insert 96 and/or a spline insert 102 made from titanium. The reaction arms 12A-12E may alternatively be made entirely of titanium. Features of the reaction arms 12A-12E corresponding with features of the reaction arm 12 are given like reference numerals, and the following description focuses primarily on differences between the various reaction arms 12A-12E.

Referring to FIGS. 7A-7B, the illustrated reaction arms 12A, 12B each include a first end 92a and a second end 92b with an angled transition portion 140 extending between the first and second ends 92a, 92b. The second end 92b is offset in front of the first end 92a such that a plane containing the tip insert 96 is parallel with a plane containing the spline insert 102. The reaction arm 12B is longer than the reaction arm 12A in the illustrated embodiment.

Referring to FIG. 7C, the illustrated reaction arm 12C has a body 92 that extends perpendicular to the axis A1. The first end 92a and the second end 92b are generally aligned such that a plane normal to the axis A1 may contain both the tip insert 96 and the spline insert 102. In the illustrated embodiment, the side walls of the tip insert 96 are flush with the side walls of the body 92; however, the side walls of the tip insert 96 may extend beyond (i.e., stand proud) relative to the walls of the body 92 to provide greater protection for the body 92 against potential wear.

With reference to FIG. 7D, the illustrated reaction arm 12D has an arcuate body 92 defining an arcuate slot 151 between the first and second ends 92a, 92b. The slot 151 slidably receives a socket 153, which may in turn receive a fastener acting as the fixed support for the reaction arm 12D. The illustrated reaction arm 12D does not include a tip insert 96; however, in some embodiments, the slot 151 may be defined by an insert made of titanium or another metal for increased wear resistance.

With reference to FIG. 7E, the illustrated reaction arm 12E includes a slot 151 similar to that of the reaction arm 12D. The illustrated reaction arm 12E further includes a drive extension 155 having an outer sleeve 157 configured to couple to the splined nose 33 of the gear case 22 and an inner drive shaft 159 configured to couple to the output drive 78 (FIG. 2). The inner drive shaft 159 is rotatable relative to the outer sleeve 157 to transmit rotation from the output drive 78. The body 92 of the reaction arm 12E may be fixed to the outer sleeve 157 or may include a spline insert, such as the spline inserts 102 described above, configured to interface with a corresponding external spline (not shown) formed on a distal end of the outer sleeve 157.

It should be understood that the reaction arms 12, 12′, 12A-E described and illustrated herein are just some examples of reaction arms that may advantageously be made from carbon fiber composite material and/or titanium or other similar materials to provide a strong, lightweight, and wear resistant reaction arm for use a reaction arm tool, such as the power tool 10.

Although the disclosure is described with reference to discrete embodiments of the power tool and reaction arm, variations of the power tool and the reaction arm exist within the spirit and scope of the disclosure.

Various features and advantages of the disclosure are set forth in the following claims.

What is claimed is:

1. A power tool comprising:
a housing;
an output operable to apply torque to a fastener; and
a reaction arm having a body with a first end coupled to the housing and a second end configured to engage a fixed structure to bear a reaction torque as the output applies torque to the fastener,
wherein the body of the reaction arm is made of carbon fiber.

2. The power tool of claim 1, wherein the reaction arm includes an insert made of metal.

3. The power tool of claim 2, wherein the insert is a first insert located proximate the first end, and wherein the reaction arm includes a second insert located proximate the second end.

4. The power tool of claim 3, wherein the first insert and the second insert are at least partially embedded in the body.

5. The power tool of claim 2, wherein the insert includes a peripheral flange embedded within the body.

6. The power tool of claim 2, wherein the insert has an inner surface with a spline geometry configured to cooperate with a corresponding spline geometry on the housing of the power tool.

7. The power tool of claim 6, wherein the housing includes a motor housing portion, a handle extending from the motor housing portion, and a gear case extending from the motor housing portion, and wherein the power tool includes a motor supported within the motor housing portion and a multi-stage planetary transmission supported within the gear case and coupled between the motor and the output.

8. The power tool of claim 7, wherein the corresponding spline geometry on the housing of the power tool is formed on the gear case.

9. The power tool of claim 8, wherein the gear case includes a plurality of internal teeth defining a ring gear of the multi-stage planetary transmission.

10. The power tool of claim 2, wherein the insert is made of titanium.

11. The power tool of claim 2, wherein the reaction arm includes an arcuate slot defined by the insert.

12. The power tool of claim 11, wherein the reaction arm includes a socket slidable along the arcuate slot.

13. The power tool of claim 2, wherein the insert includes a T-shaped extension embedded within the body of the reaction arm.

14. A power tool comprising:
a housing;
an output operable to apply torque to a fastener; and
a reaction arm having a body with a first end coupled to the housing and a second end configured to engage a fixed structure to bear a reaction torque as the output applies torque to the fastener,
wherein at least a portion of the reaction arm is made of titanium.

15. The power tool of claim 14, wherein the reaction arm includes a body made of carbon fiber and an insert made of titanium.

16. The power tool of claim 15, wherein the insert is at least partially embedded within the body.

17. The power tool of claim 16, wherein the insert is a first insert, the first insert being engageable with the housing to rotationally fix the reaction arm relative to the housing, and wherein the reaction arm further includes a second insert at least partially embedded within the body, the second insert including a surface configured to engage the fixed structure.

18. A reaction arm for use with a power tool, the reaction arm comprising:
a body made of carbon fiber, the body having a first end configured to be coupled to the power tool and a second end configured to engage a fixed structure to bear a reaction torque;
a first insert coupled to the body proximate the first end; and
a second insert coupled to the body proximate the second end,
wherein the first insert and the second insert are made of a different material than the body.

19. The reaction arm of claim 18, wherein the first insert and the second insert are made of metal.

20. The reaction arm of claim 19, wherein the first insert and second insert are made of titanium.
